(19) United States
(12) Patent Application Publication
(10) Pub. No.: US 2010/0001552 A1
(43) Pub. Date: Jan. 7, 2010

(54) MOUNTING STRUCTURE FOR COWL CROSSBAR

(75) Inventor: Sun Ho KIM, Gyeonggi-do (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/270,726

(22) Filed: Nov. 13, 2008

(30) Foreign Application Priority Data
Jul. 1, 2008 (KR) 10-2008-63493

(51) Int. Cl. B62D 25/00

(52) U.S. Cl. 296/193.02; 296/192; 296/187.12

(57) ABSTRACT

A mounting structure for a cowl crossbar includes a front pillar, a cowl crossbar provided on an inside portion of the front pillar, and a cowl crossbar mounting member for mounting the cowl crossbar on the inside of the front pillar. The cowl crossbar mounting member includes guide pins provided on a inner side of the front pillar, a cowl crossbar bracket supported by an end of the cowl crossbar and having guide portions for guiding the guide pins, and a pipe bolt fastened to the end of the cowl crossbar through the cowl crossbar bracket. The cowl crossbar is mounted on the front pillar by using the cowl crossbar mounting member so that the cowl crossbar is engaged to the side of a vehicle in a straight line.

### CROSS-REFERENCE TO RELATED APPLICATION

The present application claims priority to Korean Patent Application No. 10-2008-63493, filed on Jul. 1, 2008, the entire contents of which is incorporated herein for all purpose by this reference.

### BACKGROUND OF THE INVENTION

1. Field of the Invention

The present invention relates to a cowl crossbar assembly, and more particularly, to a mounting structure for a cowl crossbar, which can easily and conveniently mount the cowl crossbar on a chassis and reduce recession of the chassis penetrating into an interior of a vehicle upon lateral collision of the vehicle.

2. Description of Related Art

A cowl crossbar is generally installed on an interface portion between an engine compartment and an interior of a vehicle body in order to mount a steering system to a chassis, support air conditioning ducts, and serve as a reinforcing bar for an instrument panel.

Such a cowl crossbar is interposed between front pillars and serves to restrict rearward motion of a steering device upon front collision of a vehicle, reduce recession of the chassis penetrating into an interior of the vehicle upon lateral collision, and prevent vibration of a vehicle body, thereby improving the safety of passengers.

FIGS. 1 and 2 show a conventional mounting structure for a cowl crossbar.

The conventional mounting structure for a cowl crossbar includes, as shown in FIG. 1, cowl mounting brackets 20 welded to both inner sides of a front pillar 10, and cowl crossbar brackets 31 provided on both ends of a cowl crossbar 30 and engaged to the cowl mounting brackets 20 by bolts 32.

More specifically, after the cowl crossbar 30 is inserted into the inside of the front pillar 10, the cowl crossbar brackets 31 are seated on the cowl mounting brackets 20, and then are engaged to the cowl mounting brackets 20 by using the bolts 32.

With the conventional mounting structure for the cowl crossbar, as shown in FIG. 2, collision energy is diagonally transmitted from the front pillar 10 through the cowl mounting brackets 20 to the cowl crossbar 30 upon lateral collision of a vehicle. Therefore, the recession of the chassis protruding into the interior of a vehicle is increased, which lowers the safety of passengers.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Accordingly, various aspects of the present invention are directed to solving the above-mentioned problems of the prior art while maintaining certain advantages of the prior art.

One aspect of the present invention is to provide a mounting structure for a cowl crossbar, which can conveniently mount the cowl crossbar on a chassis and reduce recession of the chassis penetrating into an interior of a vehicle through coupling of the cowl crossbar to a side of the vehicle in a straight line, thereby improving the safety of passengers.

In order to accomplish these aspects, a mounting structure for a cowl crossbar is provided which, in accordance with the present invention, may include a front pillar including a through-hole; a cowl crossbar provided on the inner side of the front pillar; and a cowl crossbar mounting member for mounting the cowl crossbar on the inner side of the front pillar. The cowl crossbar mounting member preferably includes: at least a guide pin provided on a inner side of the front pillar and protruding forwards therefrom; a cowl crossbar bracket supported by an end of the cowl crossbar and having guide portions for guiding the guide pin; and a pipe bolt freely-rotatably coupled to the end of the cowl crossbar through the cowl crossbar bracket.

The longitudinal axis of the pipe bolt may be aligned substantially co-axial to the through-hole.

A head portion of the pipe blot may protrude towards the through-hole of the front pillar so as to rotate the pipe bolt.

The cowl crossbar mounting member may further include a pipe nut fastened to the end of the cowl crossbar and engaged with the pipe bolt so that the pipe nut can move forward or rearward by rotation of the pipe bolt.

The cowl crossbar mounting member may further include at least a fastening member coupling the front pillar and the cowl crossbar bracket. The fastening member may include a fastening bolt that penetrates the front pillar and the cowl crossbar bracket, and that is fastened to a fastening nut.

The cowl crossbar mounting member may further include a bolt cap having a hole to receive a head portion of the pipe bolt therethrough to cooperatively fix the pipe bolt to a rear surface of the cowl crossbar bracket and to rotate the pipe bolt through the through-hole of the front pillar. The pipe bolt may further include a support portion free-rotatably interposed between the bolt cap and the cowl crossbar bracket.

The cowl crossbar mounting member may further include a guide bracket coupling the cowl crossbar to the cowl crossbar bracket. The guide bracket may be attached to the end of the cowl crossbar and has a hole thereon, and an insertion pin is provided on one side of the cowl crossbar bracket and inserted in the hole of the guide bracket.

The guide portion of the cowl crossbar bracket may be provided with a guide groove for guiding the guide pin, and a locking groove extending upwardly from an end of the guide groove, for locking and supporting the guide pin.

In another aspect of the present invention, a mounting structure for a cowl crossbar may include a front pillar including a through-hole; the cowl crossbar provided on the inner side of the front pillar; and a cowl crossbar mounting member for mounting the cowl crossbar on the inner side of the front pillar, wherein the cowl crossbar mounting member includes: guide pin provided on a inner side of the front pillar and protruding forwards therefrom; a cowl crossbar bracket supported by an end of the cowl crossbar and having guide portions, wherein the guide portion is provided with a guide groove for guiding the guide pin, and a locking groove extending upwardly from an end of the guide groove, for locking and supporting the guide pin; and a pipe bolt freely-rotatably coupled to the end of the cowl crossbar through the cowl crossbar bracket, wherein a head portion of the pipe blot protrudes towards the through-hole of the front pillar so as to rotate the pipe bolt; a pipe nut fastened to the end of the cowl crossbar and engaged with the pipe bolt so that the pipe nut can move forward or rearward by rotation of the pipe bolt; fastening member coupling the front pillar and the cowl crossbar bracket; a bolt cap having a hole to receive a head portion of the pipe bolt therethrough to cooperatively fix the pipe bolt to a rear surface of the cowl crossbar bracket and to rotate the pipe bolt through the through-hole of the front pillar; and a guide bracket coupling the cowl crossbar to the cowl crossbar bracket.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a conventional mounting structure for a cowl crossbar.

FIG. 2 is a view illustrating the lateral corrosion state of a conventional mounting structure for a cowl crossbar.

FIG. 3 is an exploded perspective view illustrating an exemplary mounting structure for a cowl crossbar according to an aspect of the present invention.

FIG. 4 is a perspective view illustrating the assembled state of an exemplary mounting structure for a cowl crossbar according to an aspect of the present invention.

FIG. 5 is a cross-sectional view of the mounting structure in FIG. 4.

FIG. 6 is a cross-sectional view illustrating the operation of a cowl crossbar according to an aspect of the present invention.

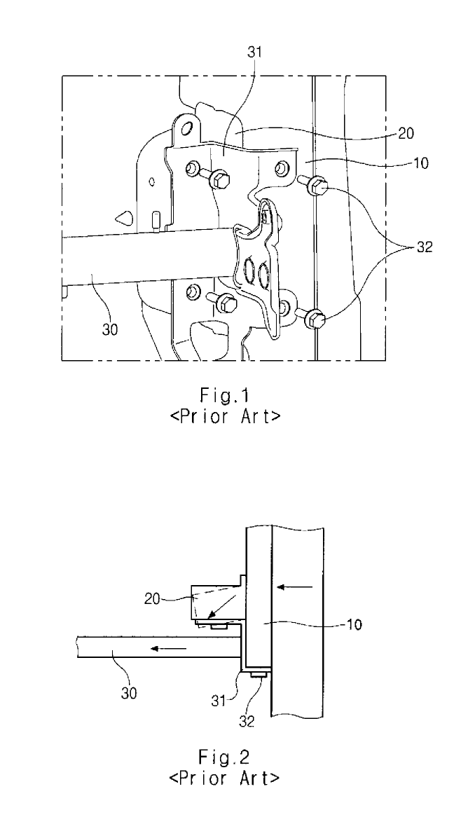

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

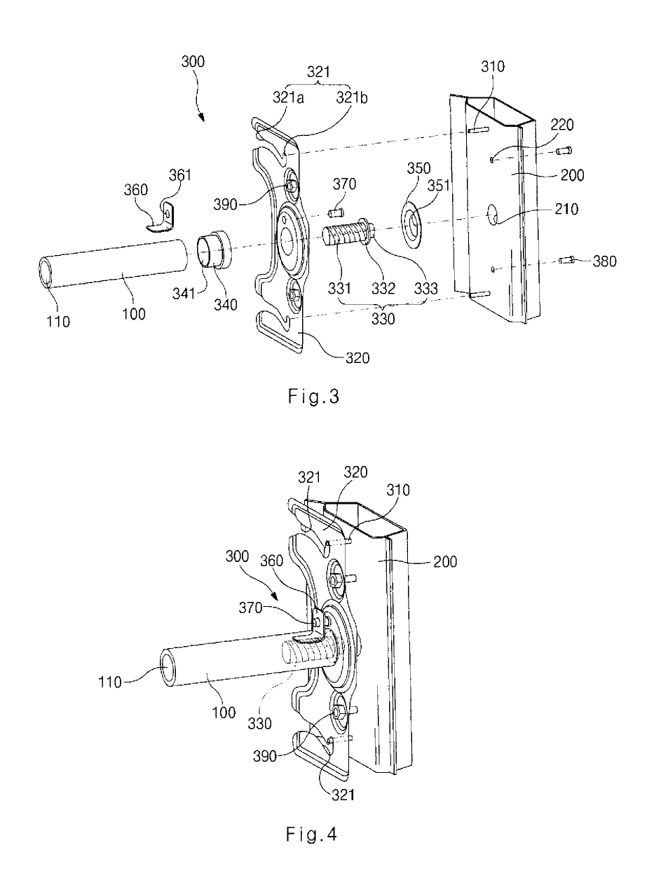

A mounting structure for a cowl crossbar according to a preferred embodiment of the present invention will now be described in detail with reference to FIGS. 3 to 6.

A cowl crossbar 100 is provided on an interface portion between an engine compartment of a vehicle and an interior of a vehicle body. The cowl crossbar 100 is installed on a front pillar 200, the cowl crossbar 100 being mounted on a surface or panel of the front pillar 200 by a cowl crossbar mounting member 300.

The cowl crossbar 100 may have a hollow portion 110, with both ends thereof being opened. A pipe nut 340 is coupled to an end of the hollow portion 10.

The front pillar 200 is provided with through-holes 210, through which a head portion of the pipe bolt 330 passes, and bolt holes 220 formed at upper and lower portions with respect to the through-hole 210, through which fastening bolts 380 pass.

The cowl crossbar mounting member 300 is configured to mount the cowl crossbar 100 on the front pillar 200 in a straight line, as shown in FIGS. 3 and 4, and includes guide pins 310, a cowl crossbar bracket 320, the pipe bolt 330, the pipe nut 340, a bolt cap 350, a guide bracket 360, an insertion pin 370, the fastening bolts 380, and fastening nuts 390.

The guide pins 310 are configured to guide the cowl crossbar bracket 320 to a predetermined position, and are coupled to the inner side of the front pillar 200, that is, the upper and lower portions with respect to the bolt holes 220, the guide pins 310 protruding from the inner side of the front pillar 200.

The cowl crossbar bracket 320 is configured to support the end of the cowl crossbar 100 on the front pillar 200, and includes guide portions 321, with a center portion of the guide portion 321 being supported by the cowl crossbar 100 and upper and lower portions thereof guiding the guide pins 310.

Each of the guide portions 321 is provided with a guide groove 321a for guiding the guide pin 310 and a locking groove 321b upwardly extending from an end of the guide groove 321a for locking and supporting the guide pin 310.

More specifically, if the cowl crossbar bracket 320 is moved toward the guide pins 310, the guide pins 310 are inserted along the guide grooves 321a of the guide portions 321, and then are supported by the ends of the guide grooves 321a. In this instance, when the cowl crossbar bracket 320 is pressed downwards, the guide pins 310 are inserted in and locked by the locking grooves 321b.

The pipe bolt 330 is configured to fix the cowl crossbar bracket 320 to the end of the cowl crossbar 100, and may be fastened to the hollow portion 110 of the cowl crossbar 100 through a rear center portion of the cowl crossbar bracket 320.

More specifically, the pipe bolt 330 is provided with a threaded portion 331 on one side thereof, the treaded portion being fastened to the pipe nut 340 through the center portion of the cowl crossbar 100, and a support portion 332 formed on one side of the threaded portion 331. The support portion 332 has a diameter larger than that of the threaded portion 331 and is supported by the rear surface of the cowl crossbar bracket 320. The support portion 332 may be provided with a square or hexagonal head portion 333 on one portion thereof.

Consequently, when the head portion 333 of the pipe bolt 330 is rotated by a tool (not shown), the threaded portion 331 is rotated around the pipe nut 340, and simultaneously is moved forward or rearward.

The pipe nut 340 is configured to fasten the pipe bolt 330 to one end of the cowl crossbar 100. One end of the pipe nut 340 may be inserted in the hollow portion 10 of the cowl crossbar 100, and the other end is supported by the center portion of the cowl crossbar bracket 320. The pipe nut 340 is provided inside the center portion thereof with a threaded groove 341 that is threadably engaged with the threaded portion 331 of the pipe bolt 330.

More specifically, the cowl crossbar bracket 320 is interposed between the pipe bolt 330 and the pipe nut 340 to prevent the cowl crossbar bracket 320 from being released.

The bolt cap 350 is configured to couple the pipe bolt 330 with the cowl crossbar bracket 320. The bolt cap 350 is welded or fastened to the rear, center portion of the cowl crossbar bracket 320 that is engaged with the pipe bolt 330. The bolt cap 350 is provided with a through-hole 351 at the center portion thereof, through which the head portion 333 of the pipe bolt 330 may pass.

More specifically, by fixing the bolt cap 350 to the rear, center portion of the cowl crossbar bracket 320, the support portion 332 of the pipe bolt 330 is free-rotatably interposed between the bolt cap 350 and the cowl crossbar bracket 320. Consequently, the cowl crossbar bracket 320 is moved forward or rearward by the forward or rearward movement of the pipe bolt 330.

The guide bracket 360 and the insertion pin 370 are configured to prevent rotation of the cowl crossbar bracket 320. The guide bracket 360 is formed in an elbow shape, in which a horizontal portion is attached to the outer surface of the one end of the cowl crossbar 100, and a vertical portion has a hole 361 through which the insertion pin 370 passes.

The insertion pin 370 is coupled to one side of the cowl crossbar bracket 320 that is substantially flush with the guide bracket 360.

More specifically, the crossbar bracket 320 is supported on the cowl crossbar 100 by using the pipe bolt 330 and the pipe nut 340, and simultaneously, the insertion pin 370 is inserted in the hole 361 of the guide bracket 360. Consequently, the cowl crossbar bracket 320 can be fixed in a vertical state, so that the cowl crossbar bracket 320 is easily inserted in the guide pin 310.

The fastening bolts 380 and the fastening nuts 390 are configured to fasten the cowl crossbar bracket 320 to a surface or panel of the front pillar 200. In a state where the cowl crossbar bracket 320 closely contacts the front pillar 200, the fastening bolt 380 passes through the through-hole 210 of the front pillar 200 and the cowl crossbar bracket 320, and then is fastened to the fastening nut 390.

The assembling process and operation of the mounting structure of the cowl crossbar according to the present invention will now be described.

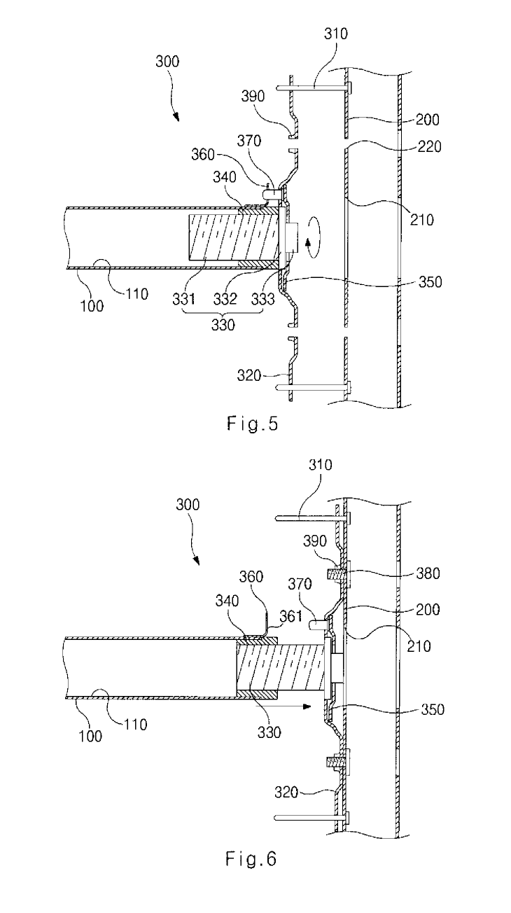

As shown in FIG. 5, after the pipe nut 340 is inserted in one end of the cowl crossbar 100, the pipe nut 340 is supported on the front, center portion of the pipe nut 340. Then, the pipe bolt 330 is fastened to the pipe nut 340 at the rear, center portion of the cowl crossbar bracket 320.

In this instance, the pipe bolt 330 is inserted in the pipe nut 340 as tight as possible to prevent the cowl crossbar bracket 320 from being moved. At the same time, the insertion pin 370 is inserted in the hole 361 of the guide bracket 360 to position the cowl crossbar bracket 320 in a vertical state.

And then, the bolt cap 350 is welded to the rear, center portion of the cowl crossbar bracket 320.

The cowl crossbar 100 mounted with the cowl crossbar bracket 320 is placed on the inner side of the front pillar 200, and then the cowl crossbar 100 is coupled to the inner side of the front pillar 200, in a state where the guide portion 321 is positioned to correspond to the guide pin 310.

As shown in FIG. 6, the guide pin 310 is guided along the guide groove 321a of the guide portion 321 formed on the cowl crossbar bracket 320, so that the guide pin 310 is inserted into the end of the guide groove 321a.

When the cowl crossbar bracket 320 is pressed down, the guide pin 310 is locked in the locking groove 321b.

After a working tool (for example, a spanner) is engaged with the head portion 333 of the pipe bolt 330 through the through-hole of the front pillar 200, the pipe bolt 330 is rotated.

Thus, while the pipe bolt 330 is rotated, the pipe bolt 330 is released from the pipe nut 340, and the cowl crossbar bracket 320 is supported on the surface of the front pillar 200 in cooperation with the pipe bolt 330.

In this instance, the mounting process of the cowl crossbar 100 is completed by fastening the fastening bolt 380 to the fastening nut 390 through the bolt holes 220 of the front pillar 200 and the cowl crossbar bracket 320.

Consequently, even though lateral collision of a vehicle occurs, it is possible to reduce remarkably the strain of the chassis, since the cowl crossbar 100 is mounted on the chassis of the vehicle along a straight line.

With the above construction, it is possible to reduce recession of the chassis penetrating into the interior of the vehicle upon lateral collision, thereby improving the safety of passengers. Also, the cowl crossbar can be easily mounted on the front pillar.

Although one end of the cowl crossbar 100 is mounted on one front pillar in this embodiment of the present invention, it will be noted that the other end of the cowl crossbar is mounted on the other front pillar. Since the construction and assembling process thereof are substantially identical to this embodiment, its description will be omitted herein, for its clarity.

For convenience in explanation and accurate definition in the appended claims, the terms “upper”, “down” or “lower”, “front” or “rear”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting structure for a cowl crossbar, comprising:
a front pillar including a through-hole;
the cowl crossbar provided on side of the front pillar; and
a cowl crossbar mounting member for mounting the cowl crossbar on the side of the front pillar;
wherein the cowl crossbar mounting member includes:
a guide pin provided on the side of the front pillar and protruding therefrom;
a cowl crossbar bracket supported by an end of the cowl crossbar and having guide portions for guiding the guide pin; and
a pipe bolt freely-rotatably coupled to the end of the cowl crossbar through the cowl crossbar bracket.

2. The mounting structure as claimed in claim 1, wherein longitudinal axis of the pipe bolt is aligned substantially co-axial to the through-hole.

3. The mounting structure as claimed in claim 1, wherein a head portion of the pipe blot protrudes towards the through-hole of the front pillar so as to rotate the pipe bolt.

4. The mounting structure as claimed in claim 1, wherein the cowl crossbar mounting member further includes a pipe nut fastened to the end of the cowl crossbar and engaged with the pipe bolt so that the pipe nut can move forward or rearward by rotation of the pipe bolt.

5. The mounting structure as claimed in claim 1, wherein the cowl crossbar mounting member further includes at least a fastening member coupling the front pillar and the cowl crossbar bracket.

6. The mounting structure as claimed in claim 5, wherein the fastening member includes a fastening bolt that penetrates the front pillar and the cowl crossbar bracket, and that is fastened to a fastening nut.

7. The mounting structure as claimed in claim 1, wherein the cowl crossbar mounting member further includes a bolt cap having a hole to receive a head portion of the pipe bolt therethrough to cooperatively fix the pipe bolt to a rear surface of the cowl crossbar bracket and to rotate the pipe bolt through the through-hole of the front pillar.

8. The mounting structure as claimed in claim 7, wherein the pipe bolt further includes a support portion free-rotatably interposed between the bolt cap and the cowl crossbar bracket.

9. The mounting structure as claimed in claim 1, wherein the cowl crossbar mounting member further includes a guide bracket coupling the cowl crossbar to the cowl crossbar bracket.

10. The mounting structure as claimed in claim 9, wherein the guide bracket is attached to the end of the cowl crossbar and has a hole thereon, and an insertion pin is provided on one side of the cowl crossbar bracket and inserted in the hole of the guide bracket.

11. The mounting structure as claimed in claim 1, wherein the guide portion of the cowl crossbar bracket is provided with a guide groove for guiding the guide pin, and a locking groove extending upwardly from an end of the guide groove, for locking and supporting the guide pin.

12. A mounting structure for a cowl crossbar, comprising:
a front pillar including a through-hole;
the cowl crossbar provided on the inner side of the front pillar; and
a cowl crossbar mounting member for mounting the cowl crossbar on the inner side of the front pillar, wherein the cowl crossbar mounting member includes:
at least a guide pin provided on a inner side of the front pillar and protruding forwards therefrom;
a cowl crossbar bracket supported by an end of the cowl crossbar and having guide portions, wherein the guide portion is provided with a guide groove for guiding the guide pin, and a locking groove extending upwardly from an end of the guide groove, for locking and supporting the guide pin; and
a pipe bolt freely-rotatably coupled to the end of the cowl crossbar through the cowl crossbar bracket, wherein a head portion of the pipe blot protrudes towards the through-hole of the front pillar so as to rotate the pipe bolt;
a pipe nut fastened to the end of the cowl crossbar and engaged with the pipe bolt so that the pipe nut can move forward or rearward by rotation of the pipe bolt;
at least a fastening member coupling the front pillar and the cowl crossbar bracket;
a bolt cap having a hole to receive a head portion of the pipe bolt therethrough to cooperatively fix the pipe bolt to a rear surface of the cowl crossbar bracket and to rotate the pipe bolt through the through-hole of the front pillar; and
a guide bracket coupling the cowl crossbar to the cowl crossbar bracket.

13. A passenger vehicle comprising the mounting structure as claimed in claim 1.

14. A passenger vehicle comprising the mounting structure as claimed in claim 12.
